(19) United States
(12) Patent Application Publication
(10) Pub. No.: US 2010/0033091 A1
(43) Pub. Date: Feb. 11, 2010

(54) LIGHT EMITTING UNIT AND METHOD OF MANUFACTURING THE LIGHT EMITTING UNIT

(75) Inventors: Wei Shen, Changhua Hsien (TW); Yuan-Lin Lee, Changhua Hsien (TW); Yu-Chien Yang, Changhua Hsien (TW)

Correspondence Address: WPAT, PC;INTELLECTUAL PROPERTY ATTORNEYS, 2030 MAIN STREET, SUITE 1300, IRVINE, CA, 92614, US

(73) Assignee: GLORY SCIENCE CO., LTD., Changhua Hsien (TW)

(21) Appl. No.: 12/188,914

(22) Filed: Aug. 8, 2008

(51) Int. Cl. H01J 1/02; H01J 9/02

(52) U.S. Cl. 313/512; 445/50

(57) ABSTRACT

A method of manufacturing a light emitting unit includes steps of previously setting a threshold of luminous intensity, measuring luminous intensity of a measured light emitting unit, calculating an offset value between the threshold of luminous intensity and the measured luminous intensity, performing absorption of light by a light absorbing portion direct proportion to the offset value, and positioning the designed light absorbing portion onto an optical element of the measured light emitting unit. While light beam is radiated from the measured light emitting unit and passed through the light absorbing portion, few light energy is absorbed by the light absorbing portion to decrease the luminous intensity. Therefore, the light emitting unit with the light absorbing portion has a consistent luminous intensity due to the light absorbing ratio of the light absorbing portion is direct proportion to the offset luminous intensity.

### BACKGROUND OF THE INVENTION

1. Field of the Invention

The present invention relates to a light emitting unit and, more particularly, to a method of manufacturing a light emitting unit with a consistent luminous intensity.

2. The Related Art

Nowadays, a backlight module is a necessary component used in a display device for emitting light beam. Base on standards of RoHS, light emitting diodes (LED) have replaced cold cathode fluorescent lamps (CCFL) used in backlight module and used for light source.

A large size backlight module, for example, the dimension thereof is larger than 20 inch, is used in a television. A middle size backlight module, for example, the dimension thereof is smaller than 17 inch and larger than 12 inch, is used in a monitor of a laptop. A small size liquid crystal display device, for example, the dimension thereof is smaller than 10 inch, is used in a mobile phone, a personal digital assistant, a digital camera and etc.

Usually, the backlight module has many LEDs arranged in line or array for emitting sufficient luminous intensity. According to consideration of distribution of luminous intensity of the backlight module, all LEDs used in backlight module are needed to equip a consistent luminous intensity.

In order to manufacture a backlight module of which distribution of luminous intensity is uniform, picking and choosing LEDs equipped with a consistent luminous intensity is a necessary procedure before manufacturing the backlight module. However, the cost raised due to the LEDs of which luminous intensity are different to the consistent luminous intensity are weeded out.

### SUMMARY OF THE INVENTION

An object of the present invention is to provide a light emitting unit having a base, a light emitting chip, an encapsulant and a light absorbing portion. The light emitting chip is mounted on the base. The encapsulant is mounted on the base and encapsulates the light emitting chip to define a light emitting surface. The light absorbing portion is formed on the light emitting surface.

Another object of the present invention is to provide a method of manufacturing the light emitting unit. The manufacturing method includes:
step 1: setting a threshold of luminous intensity;
step 2: measuring a luminous intensity of a measured light emitting unit;
step 3: calculating an offset value between the threshold of luminous intensity and the measured luminous intensity of the measured light emitting unit; and
step 4: performing the light absorbing portion with a light absorbing ratio direct proportion to the offset value, and positioning the light absorbing portion on the light emitting surface of the measured light emitting unit.

While light beam is radiated from the light emitting chip and passed through the light absorbing portion, few light energy is absorbed by the light absorbing portion to decrease the luminous intensity. Therefore, the light emitting unit with the light absorbing portion has a consistent luminous intensity due to the light absorbing ratio of the light absorbing portion is direct proportion to the offset luminous intensity.

### BRIEF DESCRIPTION OF THE DRAWINGS

The present invention will be apparent to those skilled in the art by reading the following description of preferred embodiments thereof, with reference to the attached drawings, in which:

FIG. 1 is a section view showing a first embodiment of a light emitting unit according to the present invention;

FIG. 2 is a flow chart showing a method of manufacturing the light emitting unit according to the present invention;

FIG. 3 is a flow chart showing a method of manufacturing a light absorbing portion by spraying light absorbing micro pellets according to the present invention;

FIG. 4 is a section view showing the light emitting unit with the absorbing portion made of the light absorbing micro pellets according to the present invention;

FIG. 5 is a flow chart showing a method of manufacturing the light absorbing portion by adding various resins according to the present invention;

FIG. 6 is a section view showing the absorbing portion formed in a vertical laminated construction according to the present invention;

FIG. 7 is a section view showing the absorbing portion formed in a horizontal laminated construction according to the present invention;

FIG. 8 is a section view showing the absorbing portion formed in an oblique laminated construction according to the present invention;

FIG. 9 is a section view showing the absorbing portion made of mixed resins according to the present invention;

FIG. 10 is a section view showing a second embodiment of a light emitting unit according to the present invention; and

FIG. 11 is a section view showing a third embodiment of a light emitting unit according to the present invention.

### DETAILED DESCRIPTION OF THE PREFERRED EMBODIMENT

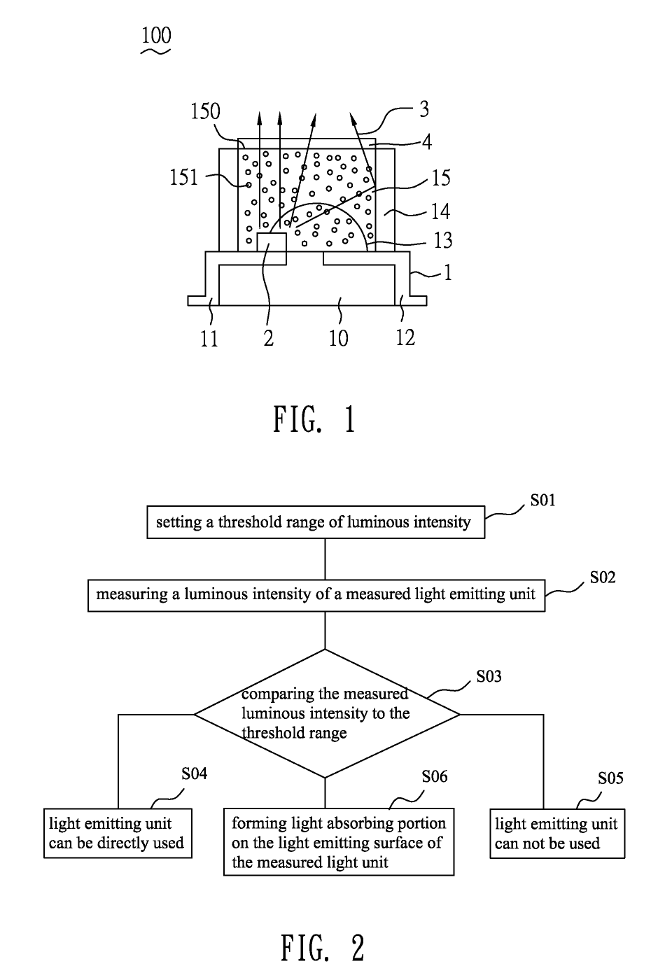

Please refer to FIG. 1, showing a first exemplary embodiment of a light emitting unit 100. The light emitting unit 100 has a base 1 and a light emitting chip 2 positioned on a top surface of the base 1. The base 1 has a substrate 10, a first metallic contact 11, a second metallic contact 12, a wire bond 13, a reflecting cap 14, and an encapsulant 15.

The first metallic contact 11 and the second metallic contact 12 are disposed on a top surface of the substrate 10. The light emitting chip 2 is mounted on and contacts to the first metallic contact 11. The wire bond 13 interconnects between the light emitting chip 2 and the second metallic contact 12. The reflecting cap 14 is mounted on the top surface of the substrate 10 in which are the light emitting chip 2 and the wire bond 13.

The encapsulant 15 is formed in the reflecting cap 14 and encapsulates the light emitting chip 2 to define a light emitting surface 150. Specifically, the encapsulant 15 is made of a transparent resin or mixed with phosphors 151.

A power source can be coupled to the first metallic contact 11 and the second metallic contact 12, and then the light emitting chip 2 is caused to radiate light beam. If the encapsulant 15 is made of transparent resin, light beam is radiated from the light emitting chip 2, through the encapsulant 15 directly and then outwardly from the light emitting surface 150. If the encapsulant 15 is made of transparent resin mixed with phosphors 151, light beam radiated from the light emitting chip 2 is excited and reflected by the phosphors 151 to alter frequency spectrum thereof, and then the altered light beam is radiated outwardly from the light emitting surface 150.

Specifically, the frequency spectrum of the light beam radiated from the light emitting surface 150 of the light emitting unit 100 can be controlled by choosing the frequency spectrum of the light beam emitted from the light emitting chip 2 and the phosphors 151. The light beam radiated from the light emitting surface 150 of the light emitting unit 100 defines a luminous path 3 (tracks of arrows in the figures). A light absorbing portion 4 is positioned in the luminous path 3, specifically positioned on the light emitting surface 150 of the light emitting unit 100.

Please refer to FIG. 2, a flow chart of a method of manufacturing the light emitting unit 100 is shown. The manufacturing method includes the following steps:
S01: previously setting a threshold range of luminous intensity;
S02: measuring a luminous intensity of a measured light emitting unit;
S03: comparing the measured luminous intensity of the measured light emitting unit and the threshold range of the luminous intensity, while the measured luminous intensity of the measured light emitting unit is included in the threshold range of the luminous intensity, S04 is performed, while the measured luminous intensity of the measured light emitting unit is below the threshold range of the luminous intensity, S05 is performed, while the measured luminous intensity of the measured light emitting unit is over the threshold range of the luminous intensity, S06 is performed;
S04: the measured light emitting unit can be directly used;
S05: the measured light emitting unit can not be used; and
S06: forming the light absorbing portion 4 on the light emitting surface 150 of the measured light emitting unit, to decrease the luminous intensity of the measured light emitting unit, to make the luminous intensity of the measured light emitting unit with the light absorbing portion 4 is in the threshold range of luminous intensity.

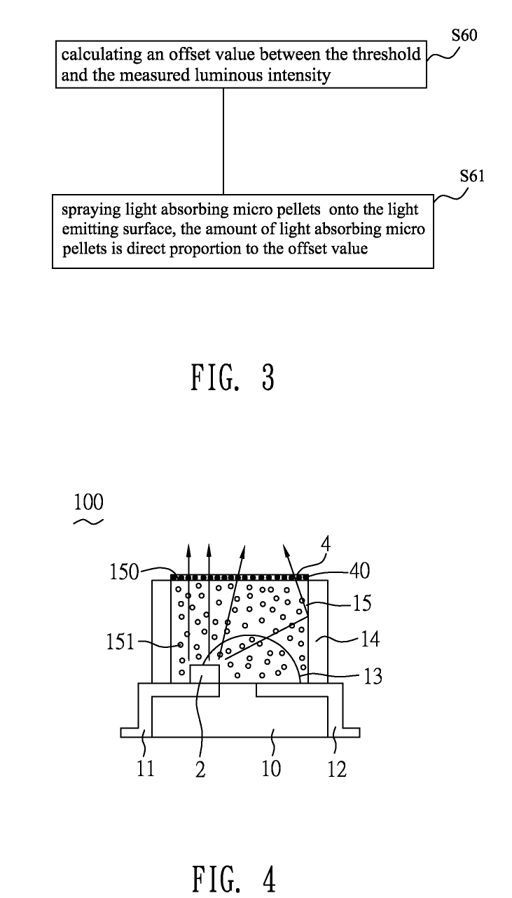

Please refer to FIG. 3, a flow chart of a method of manufacturing the light absorbing portion 4 by spraying light absorbing micro pellets 40. The manufacturing method includes the following steps:
S60: calculating an offset value between the threshold of luminous intensity and the measured luminous intensity of the measured light emitting unit; and
S61: spraying light absorbing micro pellets 40 onto the light emitting surface 150 of the light emitting unit 100, the amount of the light absorbing micro pellets 40 is direct proportion to the offset value.

Please refer to FIG. 4. In an instance, the threshold of the luminous intensity is set to 100 lm/w (lumen per watt). The threshold range of luminous intensity is set to one percent, therefore, the threshold range of luminous intensity is from 99 lm/w to 101 lm/w. While the luminous intensity of the measured light emitting unit is over 101 lm/w, light absorbing micro pellets 40 are sprayed by a spray nozzle (not shown in figures) onto the light emitting surface 150 of the measured light emitting unit to form the light absorbing portion 4.

The amount of the light absorbing micro pellets 40 is direct proportion to the offset value. The light absorbing micro pellets 40 can be continuously sprayed by a time controlled nozzle, and the amount of the light absorbing micro pellets 40 is controlled via spraying time. The light absorbing micro pellets 40 also can be sprayed at a time by an amount controlled nozzle.

Therefore, the measured light emitting unit is directly used while the luminous intensity thereof is in the threshold range of the luminous intensity. The light absorbing micro pellets 40 are sprayed onto the light emitting surface 150 of the measured light to form the light absorbing portion 4 while the luminous intensity of the measured light emitting unit is over the threshold range of the luminous intensity.

The amount of the light absorbing micro pellets relative to a light absorbing ratio of the light absorbing portion 4 is direct proportion to the offset value between the threshold of the luminous intensity and the measured luminous intensity. Therefore, the light emitting unit 100 with the light absorbing portion 4 has a consistent luminous intensity.

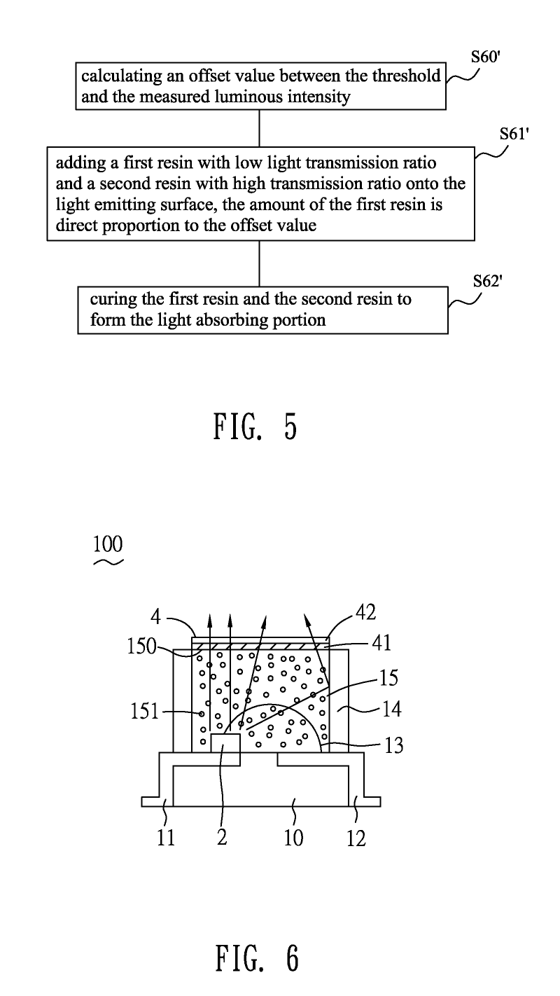

Please refer to FIG. 5, a flow chart showing a method of manufacturing the light absorbing layer by adding various resins is shown. The manufacturing method includes the following steps:
S60′: calculating an offset value between the threshold of luminous intensity and the measured luminous intensity of the measured light emitting unit;
S61′: adding a first resin 41 with low light transmission ratio and a second resin 42 with high light transmission ratio onto the light emitting surface 150 of the measured light emitting unit, the amount of the first resin 41 is direct proportion to the offset value; and
S62′: curing the first resin 41 and the second resin 42 to form the light absorbing portion 4.

In another instance, the threshold of the luminous intensity is set to 100 lm/w. The threshold range of luminous intensity is set to one percent, therefore, the threshold range of luminous intensity is from 99 lm/w to 101 lm/w. While the luminous intensity of the measured light emitting unit is between 99 lm/w and 101 lm/w, only the second resin 42 is added onto the light emitting surface 150 of the measured light emitting unit to form the light absorbing portion 4.

While the luminous intensity of the measured light emitting unit is over 101 lm/w, the first resin 41 and the second resin 42 are added onto the light emitting surface 150 of the measured light emitting unit to form the light absorbing portion 4. The light absorbing portion 4 can be cured by heating or radiating ultraviolet.

Specifically, the refractive index of the first resin 41 is same as the refractive index of the second resin 42. The first resin 41 and the second resin 42 can be added onto the light emitting surface 150 by applying means or dropping means. The amount of the first resin 41 is direct proportion to the offset value.

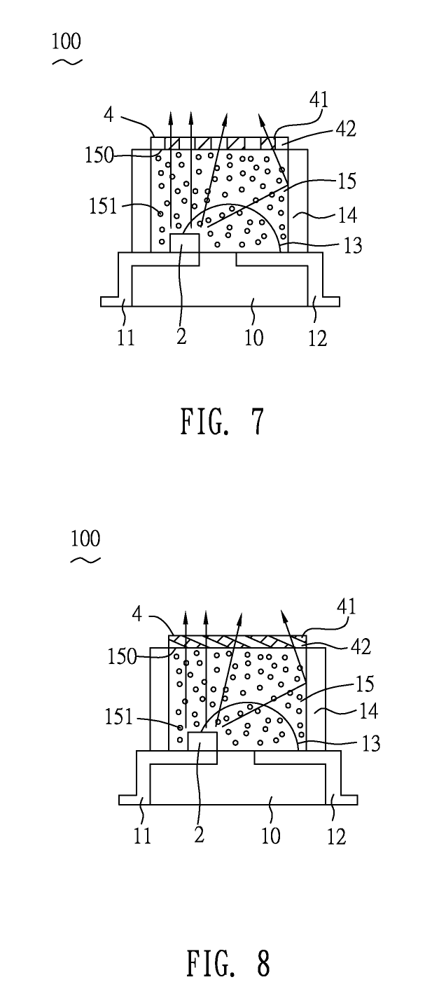

The first resin 41 and the second resin 42 can be added onto the light emitting surface 150 in turn to form a laminated construction. Please refer to FIG. 6, the light absorbing portion 4 are formed in a vertical laminated construction. FIG. 7 shows the light absorbing portion 4 is formed in a horizontally laminated construction. FIG. 8 shows the light absorbing portion 4 is formed in oblique laminated construction.

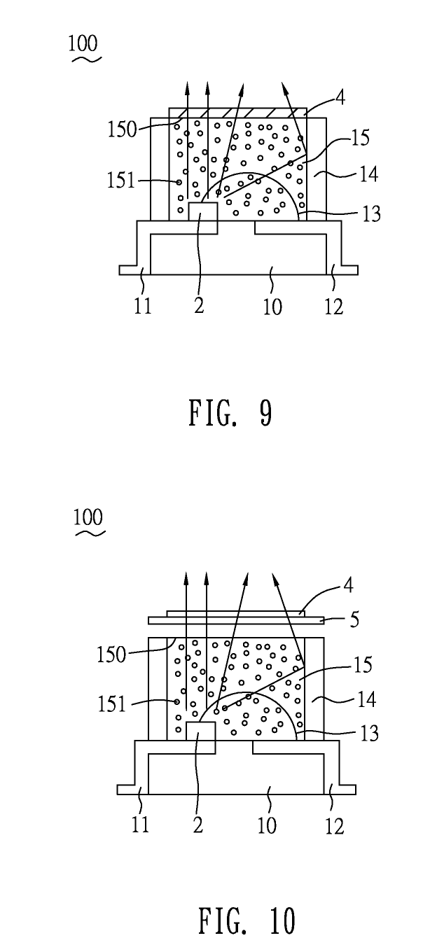

Moreover, the first resin 41 and the second resin 42 can be mixed and then added onto the light emitting surface 150. Please refer to FIG. 9, showing the light absorbing portion 4 being made of mixed first and second resins 41, 42.

Therefore, only the second resin 42 is added onto light emitting surface 150 to form the light absorbing portion 4 while the luminous intensity thereof is in the threshold range of the luminous intensity. The first resin 41 and the second resin 42 are added onto the light emitting surface 150 of the measured light to form the light absorbing portion 4 while the luminous intensity of the measured light emitting unit is over the threshold range of the luminous intensity.

The amount of the first resin 41 relative to a light absorbing ratio of the light absorbing portion 4 is direct proportion to the offset value between the threshold of the luminous intensity and the measured luminous intensity. Therefore, the light emitting unit 4 with the absorbing portion 4 has a consistent luminous intensity.

Please refer to FIG. 10, showing a second exemplary embodiment of a light emitting unit 100. The light emitting unit 100 further includes a plate-like transparent optical element 5 positioned in the luminous path 3. The light absorbing portion 4 is formed on a surface of the transparent optical element 5. The transparent optical element 5 is parallelly positioned upon and apart from the light emitting surface 150. Furthermore, the transparent optical element 5 can be connected onto the light emitting surface 150.

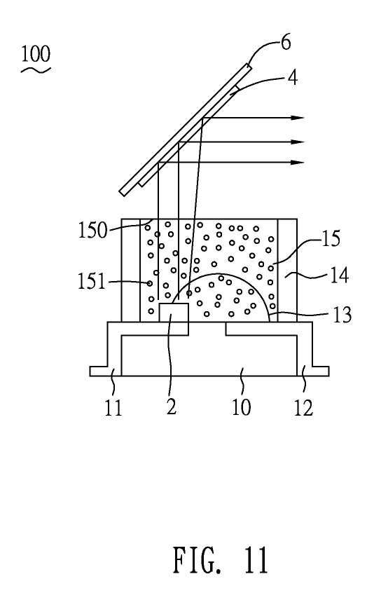

Please refer to FIG. 11, showing a third exemplary embodiment of a light emitting unit 100. The light emitting unit 100 further includes a plate-like light reflecting element 6 positioned in the luminous path 3. The light absorbing portion 4 formed on one surface of the light reflecting element 6. The light reflecting element 6 is obliquely positioned upon and apart from the light emitting surface 150.

The light beam is radiated from the light emitting chip 2, radiated outwardly from the light emitting surface 150, and then radiated through the light absorbing portion 4 on the light reflecting element 6. The light beam is therefore reflected by the light reflecting element 6 and then radiated through the light absorbing portion 4 again. The amount of light absorbing micro pellet 40 or the amount of the first resin 41 can be decreased because the light beam is radiated through the light absorbing portion 4 two times.

The light absorbing portion 4 is made of light absorbing material, such as the light absorbing micro pellets 40 and the first resin 41 with low light transmission ratio, and formed on the optical element in the luminous path 3 of the light emitting unit 100, such as light emitting surface 150 of the encapsulatnt 15, the transparent element 5 and the light reflecting element 6 to decrease luminous intensity of the light emitting unit 100.

The amount of the light absorbing micro pellets 40 and the amount of the first resin 41 with low light transmission ratio are direct proportion to the offset between the threshold of luminous intensity and the original luminous intensity of the light emitting unit 100.

While the light beam is radiated from the measured light emitting unit and passed through the light absorbing portion 4, few light energy is absorbed by the light absorbing portion 4 to decrease the luminous intensity. Therefore, the light emitting unit 100 with the light absorbing portion 4 has a consistent luminous intensity due to the light absorbing ratio of the light absorbing portion 4 is direct proportion to the offset luminous intensity.

Furthermore, the present invention is not limited to the embodiments described above; various additions, alterations and the like may be made within the scope of the present invention by a person skilled in the art. For example, respective embodiments may be appropriately combined.

What is claimed is:

1. A light emitting unit, comprising:
a base;
a light emitting chip mounted on said base;
an encapsulant mounted on said base and covering said light emitting chip, said encapsulant forming a light emitting surface; and
a light absorbing portion formed on said light emitting surface.

2. The light emitting unit as claimed in claim 1, wherein said light absorbing portion is made of light absorbing micro pellets.

3. The light emitting unit as claimed in claim 1, wherein said light absorbing portion is made of a first resin with low light transmission ratio and a second resin with high light transmission ratio.

4. The light emitting unit as claimed in claim 1, wherein said base comprises:
a substrate;
a first metallic contact disposed on a top surface of said substrate, said light emitting chip mounted on and connected to said first metallic contact;
a second metallic contact disposed on said top surface of said substrate;
a wire bone interconnected between said light emitting chip and said second metallic contact; and
a reflecting cap mounted on said top surface of said substrate in which are said light emitting chip, said wire bone and said encapsulant.

5. The light emitting unit as claimed in claim 4, wherein said encapsulant is mixed with phosphors.

6. A light emitting unit, comprising:
a base;
a light emitting chip mounted on said base;
an encapsulant mounted on said base and covering said light emitting chip, said encapsulant forming a light emitting surface, light beam radiated from said light emitting chip and radiated outwardly from said light emitting surface to define a luminous path;
an optical element positioned in said luminous path; and
a light absorbing portion formed on said optical element.

7. The light emitting unit as claimed in claim 6, wherein said light absorbing portion is made of light absorbing micro pellets.

8. The light emitting unit as claimed in claim 6, wherein said optical element is a light transparent element or a light reflecting element.

9. The light emitting unit as claimed in claim 6, wherein said light absorbing portion is made of a first resin with low light transmission ratio and a second resin with high light transmission ratio.

10. The light emitting unit as claimed in claim 6, wherein said base comprises:
a substrate;
a first metallic contact disposed on a top surface of said substrate, said light emitting chip mounted on and connected to said first metallic contact;
a second metallic contact disposed on said top surface of said substrate;
a wire bone interconnected between said light emitting chip and said second metallic contact; and
a reflecting cap mounted on said top surface of said substrate in which are said light emitting chip, said wire bone and said encapsulant.

11. The light emitting unit as claimed in claim 10, wherein said encapsulant is mixed with phosphors.

12. A method of manufacturing a light emitting unit, comprising:
setting a threshold of luminous intensity;
measuring luminous intensity of a measured light emitting unit;
calculating an offset value between said threshold of luminous intensity and said measured luminous intensity of said measured light emitting unit; and
performing an light absorbing portion with a light absorbing ratio direct proportion to said offset value, and positioning said light absorbing portion on an optical element of said measured light emitting unit.

13. The method of manufacturing a light emitting unit as claimed in claim 12, wherein said method of performing said light absorbing portion comprising:
setting a threshold range of luminous intensity; and
spraying light absorbing micro pellets onto said optical element to form said light absorbing portion if said measured luminous intensity of said measured light emitting unit being in said threshold range of luminous intensity, wherein said light absorbing ratio of said light emitting portion is direct proportion to the amount of said light absorbing pellets.

14. The method of manufacturing a light emitting unit as claimed in claim 12, wherein said method of performing said light absorbing portion comprising:
setting a threshold range of luminous intensity;
adding a first resin with low light transmission ratio and a second resin with high light transmission onto said optical element if said measured luminous intensity of said measured light emitting unit being in said threshold range of luminous intensity; and
curing said first resin and said second resin to form said light absorbing portion, wherein light absorbing ratio of said light emitting portion is direct proportion to said the amount of said first resin.

15. The method of manufacturing a light emitting unit as claimed in claim 14, wherein said first resin and said second resin of said light absorbing portion is formed in a laminated construction.

16. The method of manufacturing a light emitting unit as claimed in claim 14, wherein said first resin and said second resin are mixed and then added onto said optical element to form said light absorbing portion.

17. The method of manufacturing a light emitting unit as claimed in claim 12, wherein said optical element is a light emitting chip or a light transparent element or a light reflecting element.
